(19) United States
(12) Patent Application Publication
(10) Pub. No.: US 2026/0172681 A1
(43) Pub. Date: Jun. 18, 2026

(54) IMAGE CAPTURING APPARATUS, CONTROL METHOD THEREOF, AND IMAGE CAPTURING SYSTEM

(71) Applicant: CANON KABUSHIKI KAISHA, Tokyo (JP)

(72) Inventor: YASUHIRO KOJIMA, Tokyo (JP)

(21) Appl. No.: 19/380,379

(22) Filed: Nov. 5, 2025

(30) Foreign Application Priority Data
Dec. 12, 2024 (JP) 2024-218092

(51) Int. Cl. H04N 23/68; B64D 47/08; B64U 101/30; G03B 15/00; H04N 7/18; H04N 23/51; H04N 23/667; H04N 25/531

(52) U.S. Cl. CPC H04N 23/687; B64D 47/08; G03B 15/006; H04N 7/185; H04N 23/51; H04N 23/667; H04N 23/683; H04N 25/531; B64U 2101/30

(57) ABSTRACT

An image capturing apparatus comprises a memory storing instructions; and a processor executing the stored instructions causing the image capturing apparatus to acquire movement information regarding movement of an image capturing apparatus, move an image capturing element or a lens performing image blur correction in a direction parallel to an image capturing plane, and perform control to move the image capturing element or the lens in accordance with the movement information during first image capturing for acquiring a still image and during a second image capturing for acquiring display video. When the image capturing apparatus performs image capturing while moving, during the first image capturing, a first drive amount is calculated to move the image capturing element or the lens, and during the second image capturing, a second drive amount is calculated to move the image capturing element or the lens.

### BACKGROUND

### Field of the Technology

The present disclosure relates to technology for performing image capturing by a movable image capturing apparatus.

### Description of the Related Art

Among moving image capturing apparatuses having an image capturing unit, there are drones and unmanned aircraft called UAV (Unmanned Aerial Vehicle) that are capable of remote operation by a user. For example, in drone mapping that uses a drone on which an image capturing apparatus is mounted, surveying is performed by still image capturing. In still image capturing for surveying, because continuous capturing is performed by directing an image capturing lens toward a surveying target while the drone flies, improved surveying efficiency can be realized.

Incidentally, because a rolling shutter method that is adopted in an image capturing element is a method of reading out signals that have been photoelectrically converted by performing exposure sequentially from upper rows, there is a possibility that image distortion called rolling shutter distortion occurs. Japanese Unexamined Patent Publication No. 2011-103631 discloses technology for correction of rolling shutter distortion in a case in which an operation speed of panning is non-uniform. Based on detected camera shake components, by using a blur correction unit, control is performed to correct distortion that occurs in an image of a subject due to the rolling shutter method.

However, Japanese Unexamined Patent Publication No. 2011-103631 contains no disclosure of image capturing with respect to display video (hereinafter also referred to as live view video) that is output in real time in intervals between capturing of a plurality of still images. In addition, Japanese Unexamined Patent Publication No. 2011-103631 contains no description with respect to correction of rolling shutter distortion related to live view video. In a case in which correction of rolling shutter distortion is not performed with respect to live view video, the video becomes distorted. In a case in which a drive amount (movement amount) of an image capturing element becomes too large when outputting live view video, there is a possibility that a frame rate of the live view video decreases. In still image capturing for surveying that uses a drone that is capable of high-speed flight, there are many cases in which a user confirms a flight state of the drone by live view video at a remote location, and, in addition to correction of rolling shutter distortion, smoother video at higher frame rates is required.

### SUMMARY

The present disclosure is directed to provide an image capturing apparatus that is capable of acquiring smoother display video in which image distortion is suppressed.

According to an aspect of the present disclosure, an image capturing apparatus comprises at least one memory storing instructions; and at least one processor executing the stored instructions causing the image capturing apparatus to acquire movement information with respect to movement of an image capturing apparatus, move an image capturing element or a lens that performs image blur correction in a direction parallel to an image capturing plane, and perform control to move the image capturing element or the lens in accordance with the movement information during a first image capturing for acquiring a still image and during a second image capturing for acquiring display video. In a case in which the image capturing apparatus performs image capturing while moving, during the first image capturing, executing the stored instructions by the processor further causes the image capturing apparatus to perform control to calculate a first drive amount and move the image capturing element or the lens, and during the second image capturing, executing the stored instructions by the processor further causes the image capturing apparatus to perform control to calculate a second drive amount and move the image capturing element or the lens.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram showing an image capturing system according to an embodiment.

FIGS. 2A and 2B are diagrams showing an external appearance of an image capturing apparatus according to an embodiment.

FIG. 3 is a block diagram showing a part of a configuration of an image capturing system according to an embodiment.

FIG. 4 is a block diagram showing another part of a configuration of an image capturing system according to an embodiment.

FIG. 5 is a timing chart for explaining exposure of an image capturing element according to a first embodiment.

FIG. 6 is a flowchart for explaining processing according to the first embodiment.

FIG. 7 is a schematic diagram for explaining a movement path of a moving body.

FIG. 8 is a diagram showing a moving body during image capturing according to an embodiment.

FIGS. 9A and 9C are schematic diagrams for explaining occurrence of rolling shutter distortion.

FIGS. 10A and 10B are timing charts for explaining distortion correction processing according to the first embodiment.

FIG. 11 is a timing chart for explaining distortion correction processing according to a second embodiment.

FIGS. 12A and 12B are timing charts for explaining exposure of an image capturing element according to a third embodiment.

### DESCRIPTION OF THE EMBODIMENTS

Hereinafter, embodiments of the present disclosure are explained in detail by referring to the attached drawings. Although the embodiments show examples applied to flying bodies for surveying such as drones as moving image capturing apparatuses, the present disclosure is applicable to various image capturing systems that are provided with an image capturing unit that is capable of performing image capturing while moving.

### First Embodiment

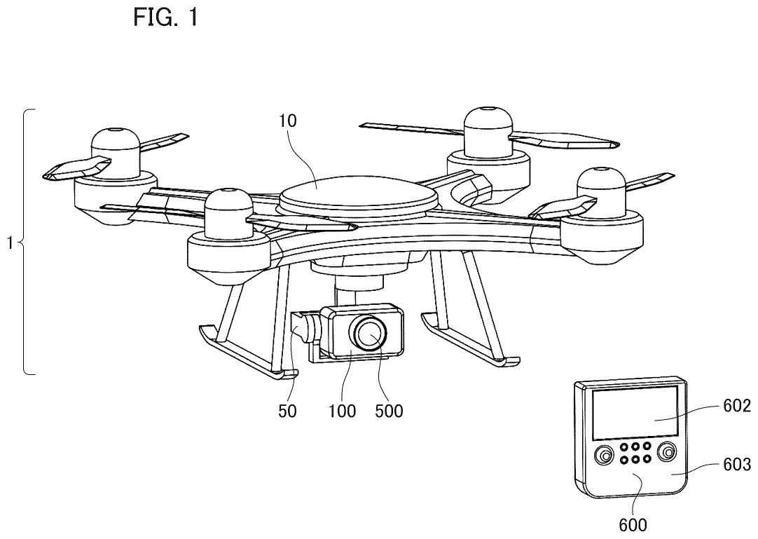

FIG. 1 is an external perspective view showing an image capturing system 1 of the present embodiment. The image capturing system 1 is configured by a moving body 10, a gimbal 50, a remote control apparatus 600, and an image capturing apparatus 100. The moving body 10 is an unmanned flying body (referred to as a drone), and an operator can perform remote control of the moving body 10 by using the remote control apparatus 600. The moving body 10 is, for example, a quadcopter on which four fan blades are mounted. It should be noted that the number of fan blades may be one or more. In addition, with respect to the moving body 10, the moving body 10 is not limited to a rotorcraft and may be configured as a fixed-wing aircraft.

The gimbal 50 is a connection apparatus that connects the moving body 10 and the image capturing apparatus 100. The gimbal 50 can rotationally support the image capturing apparatus 100 in three axial directions (a roll direction, a yaw direction, and a pitch direction) relative to the optical axis of the image capturing apparatus 100. In addition, transmission and reception of various signals and information between the moving body 10 and the image capturing apparatus 100 are performed via the gimbal 50.

The remote control apparatus 600 is a controller that performs remote control of the moving body 10 in accordance with operation instructions of the operator. The remote control apparatus 600 has a display unit 602 and an operation unit 603. The display unit 602 displays setting information of the moving body 10 and the image capturing apparatus 100, position information and movement information of the moving body 10, still images (recording images) that are captured by the image capturing apparatus 100, display video (live view video), and the like. For example, the operator that is a user can grasp the control state, confirm video, and the like by visually recognizing display video information of a display screen of the display unit 602.

The operation unit 603 has a plurality of operation members that are operated by the operator. The operation unit 603 includes operation members for movement control of the moving body 10 and operation members for setting changes of the moving body 10 and the image capturing apparatus 100. For example, the operation unit 603 is configured by a plurality of buttons and a joystick, and has a power operation switch of the remote control apparatus 600, and the like. The operator can issue a movement start instruction to the moving body 10 by operation of the operation unit 603.

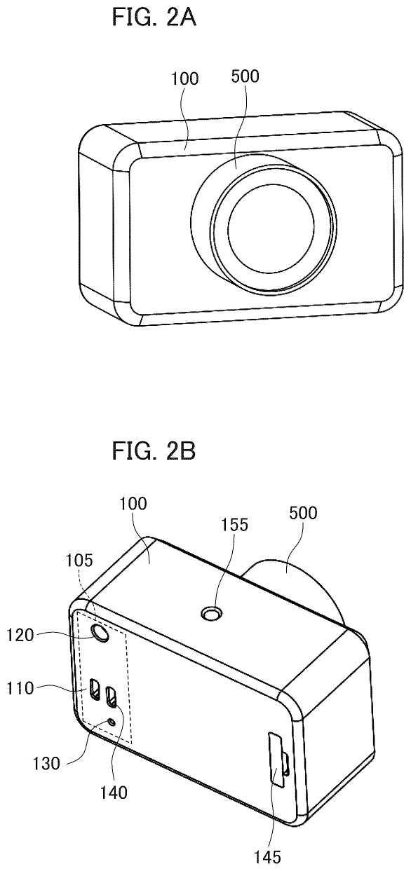

Referring to FIGS. 2A and 2B, the image capturing apparatus 100 is explained in detail. FIGS. 2A and 2B are external perspective views showing an external appearance of the image capturing apparatus 100. FIG. 2A is an upper-front perspective view of the image capturing apparatus 100. FIG. 2B is a lower-rear perspective view of the image capturing apparatus 100. The image capturing apparatus 100 is, for example, an interchangeable-lens digital camera, and attachment and detachment of the interchangeable lens 500 with respect to the main body unit are possible. Each unit is explained by defining the subject side as the front side. It should be noted that although an image capturing system in which the interchangeable lens 500 is attachable to and detachable from the main body unit of the image capturing apparatus 100 is illustrated, an image capturing system in which a lens is fixed to the main body unit of the image capturing apparatus 100 may also be provided.

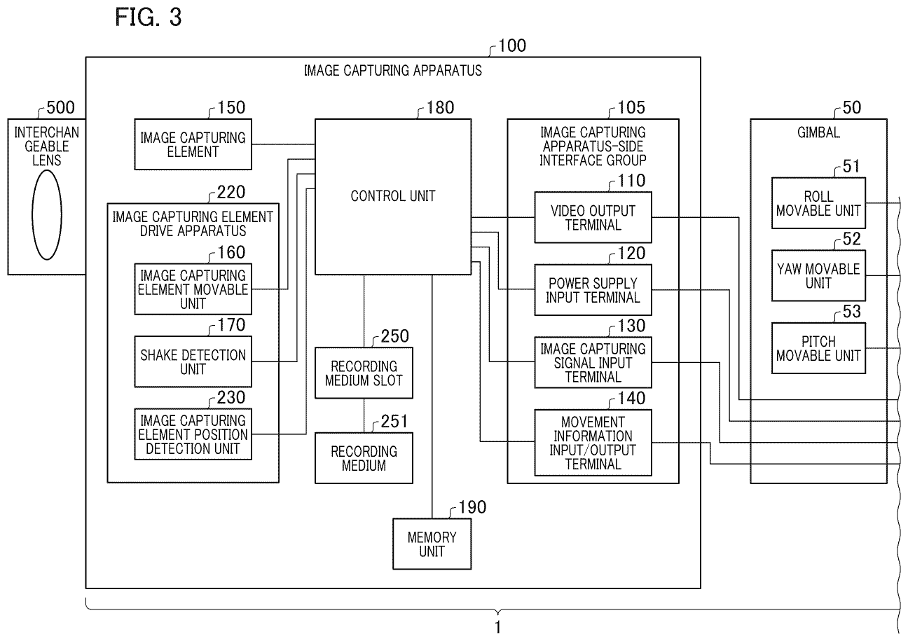

The interchangeable lens 500 is a lens unit that can be mounted on the front of the main body unit of the image capturing apparatus 100. By an image capturing optical system having a lens incorporated in the interchangeable lens 500, an image of a subject can be formed on an image capturing element described below (FIG. 3:150). For example, the interchangeable lens 500 is a single-focal-length lens unit having a focal length of 50 mm. According to the image capturing situation, a user may mount a lens unit having a different focal length on the main body unit of the image capturing apparatus 100, and a user may also mount on the main body unit of the image capturing apparatus 100 a zoom lens unit in which the focal length is changeable.

As shown in FIG. 2B, on the back surface of the main body unit of the image capturing apparatus 100, an image capturing apparatus-side interface group 105 is installed. Hereinafter, “interface” is denoted as “IF.” The image capturing apparatus-side IF group 105 has a video output terminal 110, a power supply input terminal 120, an image capturing signal input terminal 130, and a movement information input/output terminal 140.

The video output terminal 110 is a terminal that outputs a video signal indicating setting values of the image capturing apparatus 100, a captured still image signal, and a captured live view video signal. For example, the video output terminal 110 is configured as an HDMI (registered trademark, HDMI High-Definition Multimedia Interface) terminal. Alternatively, the video output terminal 110 may be configured as a USB (Universal Serial Bus) Type-C terminal.

The power supply input terminal 120 is a terminal that receives electric power that is supplied from the moving body 10 via the gimbal 50. The power supply input terminal 120 is not a general-purpose terminal or a terminal conforming to a standard such as USB, and is configured as a dedicated terminal for the image capturing apparatus 100.

The image capturing signal input terminal 130 is a terminal that receives an image capturing start signal that is transmitted from the moving body 10 via the gimbal 50. The image capturing apparatus 100 performs image capturing relating to a still image and live view video at a timing at which the image capturing start signal from the moving body 10 is received. For example, the image capturing signal input terminal 130 is configured as a terminal for a 3.5 mm mini plug.

The movement information input/output terminal 140 is a terminal that performs transmission and reception of movement information between the moving body 10 and the main body unit of the image capturing apparatus 100 via the gimbal 50. Movement information is described below.

The image capturing apparatus 100 has a moving-body fixing unit 155. The moving-body fixing unit 155 is a screw fixing unit for fixing the image capturing apparatus 100 to the gimbal 50, and for example is configured as a tripod screw. In this case, in addition to the gimbal 50, fixation is possible to an apparatus having an attachment unit corresponding to a tripod screw.

The main body unit of the image capturing apparatus 100 has a media cover 145 on the back surface. The media cover 145 is openable and closable, and a user can open the media cover 145 and perform insertion and removal of a recording medium described below (FIG. 3:251).

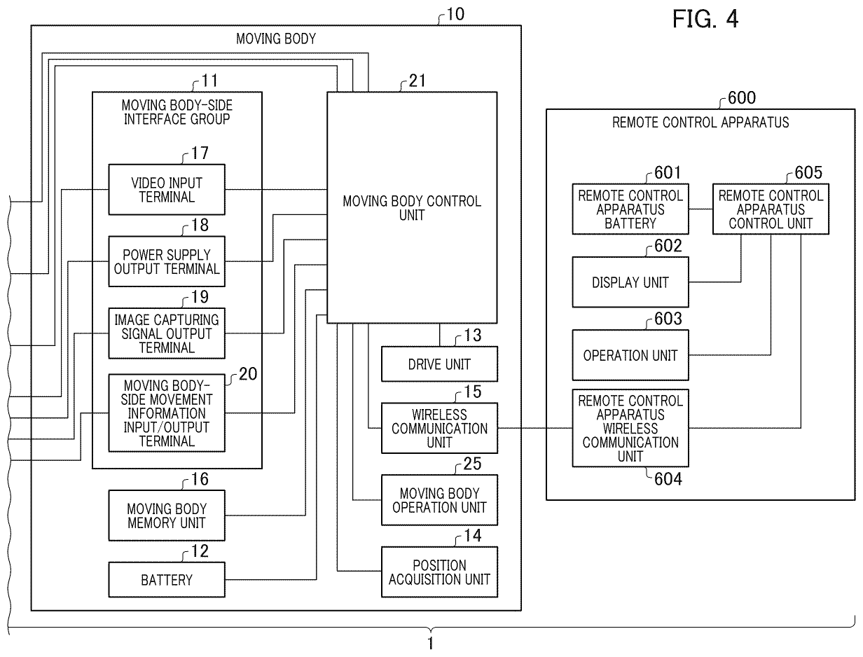

Next, referring to FIGS. 3 and 4, the image capturing system 1 is explained. FIG. 3 is a block diagram showing a configuration of the image capturing apparatus 100 and the gimbal 50 in the image capturing system 1. FIG. 4 is a block diagram showing a configuration of the moving body 10 and the remote control apparatus 600 in the image capturing system 1.

The interchangeable lens 500 can be mounted on the main body unit of the image capturing apparatus 100 (FIG. 3). The main body unit of the image capturing apparatus 100 has an image capturing element 150, an image capturing element drive apparatus 220, a control unit 180, a memory unit 190, a recording medium slot 250, the recording medium 251, and the image capturing apparatus-side IF group 105.

The image capturing element 150 is a device having a plurality of photoelectric conversion elements and, for example, is configured as a CMOS (complementary metal-oxide-semiconductor) image sensor. The image capturing element 150 outputs to the control unit 180 by photoelectrically converting to an electrical signal a subject image formed by the interchangeable lens 500. The image capturing element drive apparatus 220 is configured by a shake detection unit 170, an image capturing element movable unit 160, and an image capturing element position detection unit 230. The image capturing element drive apparatus 220 can perform drive for movement and rotation of the image capturing element 150.

The shake detection unit 170 has a sensor that detects vibration applied to the image capturing apparatus 100, and outputs a detection signal to the control unit 180. For example, the shake detection unit 170 has an acceleration sensor or an angular velocity sensor such as a gyro sensor.

The image capturing element movable unit 160 has a drive mechanism that is movable relative to an optical axis of the interchangeable lens 500. For example, the control unit 180 acquires a detection signal from the shake detection unit 170, and, based on the detected value, can perform control to move the image capturing element 150 in a direction parallel to the image capturing plane. Because a movable range of the image capturing element 150 is constrained by a configuration of the image capturing element movable unit 160, there is a limit to the movable range.

The image capturing element position detection unit 230 performs position detection of the image capturing element 150 and outputs a position detection signal to the control unit 180. The image capturing element position detection unit 230 has a sensor that detects at which position the image capturing element 150 is currently located within a movable range of the image capturing element 150 that is defined by the drive mechanism of the image capturing element movable unit 160.

By the above-described configuration, the image capturing element drive apparatus 220 can correct influence on an image due to shake applied to the image capturing apparatus 100 by mechanical driving (movement or rotation) of the image capturing element 150. It should be noted that details of a correction method of rolling shutter distortion by the image capturing element drive apparatus 220 are described below.

The control unit 180 (FIG. 3) performs control of the image capturing apparatus 100. For example, the control unit 180 has a microprocessor and executes various processing in accordance with a program. The memory unit 190 is an information storage apparatus that stores setting information of the image capturing apparatus 100 and the like, and also stores a program that has been read in advance.

The recording medium slot 250 is an IF unit that, when connected to the recording medium 251, transmits a still image signal. The recording medium 251 is an information storage apparatus that stores data of still images captured by the image capturing apparatus 100. For example, the recording medium 251 is configured as an SD card, and the recording medium slot 250 is an SD card slot.

The gimbal 50 (FIG. 3) has a roll movable unit 51, a yaw movable unit 52, and a pitch movable unit 53. The roll movable unit 51 is a rotation drive unit that rotates the image capturing apparatus 100 in a roll direction. The yaw movable unit 52 is a rotation drive unit that rotates the image capturing apparatus 100 in a yaw direction. The pitch movable unit 53 is a rotation drive unit that rotates the image capturing apparatus 100 in a pitch direction. Cables that connect each terminal of the image capturing apparatus-side IF group 105 and each terminal of a moving body-side IF group 11 (FIG. 4) described below are installed inside the gimbal 50. It should be noted that although an image capturing system in which the main body unit of the image capturing apparatus 100 is removably fixed to the gimbal 50 is illustrated, an image capturing system in which the main body unit of the image capturing apparatus 100 is non-removably fixed to the gimbal 50 may be provided.

The moving body 10 (FIG. 4) has a moving body control unit 21, a moving body memory unit 16, a moving body-side IF group 11, a battery 12, a drive unit 13, a position acquisition unit 14, a wireless communication unit 15, and a moving body operation unit 25.

The moving body control unit 21 performs control of the moving body 10. For example, the moving body control unit 21 has a microprocessor, and executes various processing in the moving body 10 in accordance with a program. The moving body memory unit 16 is an information storage apparatus that stores setting values and programs read in advance into the moving body 10. The moving body memory unit 16 stores information of a movement path of the moving body 10 described below.

The moving body-side IF group 11 connected to the moving body control unit 21 has a video input terminal 17, a power supply output terminal 18, an image capturing signal output terminal 19, and a movement information input/output terminal 20. The video input terminal 17 is a terminal that forms a pair with the video output terminal 110 of the image capturing apparatus-side IF group 105, and the terminals are connected by a cable. The power supply output terminal 18 is a terminal that forms a pair with the power supply input terminal 120 of the image capturing apparatus-side IF group 105, and these terminals are connected by a cable. The image capturing signal output terminal 19 is a terminal that forms a pair with the image capturing signal input terminal 130 of the image capturing apparatus-side IF group 105, and the terminals are connected by a cable. The movement information input/output terminal 20 on the moving body side is a terminal that forms a pair with the movement information input/output terminal 140 of the image capturing apparatus-side IF group 105, and these terminals are connected by a cable. The movement information input/output terminal 20 is a terminal equivalent to the movement information input/output terminal 140.

The battery 12 is a secondary battery that supplies electric power to each constituent unit of the moving body 10, and can also store electric power by charging. Electric power of the battery 12 is also supplied to the gimbal 50. In addition, electric power of the battery 12 is supplied to the image capturing apparatus 100 via a cable from the power supply output terminal 18 to the power supply input terminal 120.

The drive unit 13 is a propulsion apparatus for moving the moving body 10 by rotating the fan blades. The drive unit 13 is controlled by the moving body control unit 21. The position acquisition unit 14 acquires position information of the moving body 10 and outputs the position information to the moving body control unit 21. The position acquisition unit 14 is an apparatus that acquires position information and is configured based on, for example, GNSS (Global Navigation Satellite System). The moving body control unit 21 performs a calculation by acquiring position information of the moving body 10 from the position acquisition unit 14, and calculates movement speed information and movement direction information related to the moving body 10. The position information also includes altitude information of the moving body 10.

The wireless communication unit 15 is a wireless apparatus that performs wireless communication with a wireless communication unit 604 provided in the remote control apparatus 600, and performs transmission and reception of various information and signals. The wireless communication unit 15 is controlled by the moving body control unit 21.

The moving body operation unit 25 has a power switch for the moving body 10, and operation members including buttons, dials, and the like. A user can issue instructions for various settings of the moving body 10 and changes to the settings by operation of the moving body operation unit 25.

The remote control apparatus 600 (FIG. 4) has a control unit 605, a wireless communication unit 604, a battery 601 of the remote control apparatus 600, a display unit 602, and an operation unit 603. The control unit 605 of the remote control apparatus 600 has, for example, a microprocessor, and executes various processing in the remote control apparatus 600 in accordance with a program. The wireless communication unit 604 can perform wireless communication with the wireless communication unit 15 of the moving body 10, and can transmit and receive various information and signals. The battery 601 is a secondary battery that supplies electric power to each constituent unit of the remote control apparatus 600, and can also store electric power by charging. It should be noted that the display unit 602 and the operation unit 603 are as described above. It should be noted that although a controller that performs remote control of the moving body 10 in accordance with operation instructions of an operator is illustrated as the remote control apparatus 600, the remote control apparatus 600 may also be a remote control apparatus that moves the moving body 10 by transmitting control information such as pre-programmed movement patterns to the moving body 10.

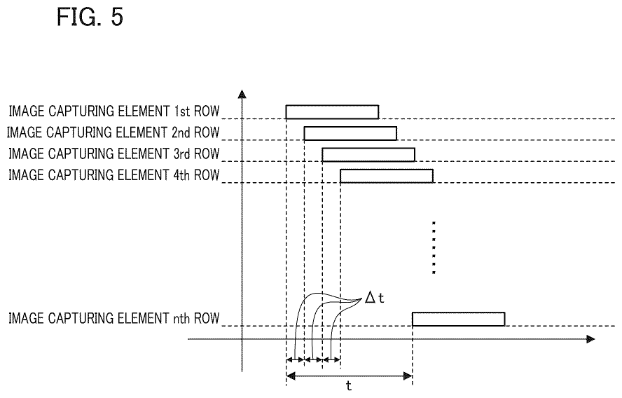

Next, referring to FIG. 5, exposure of the image capturing element 150 is explained. FIG. 5 is a timing chart for explaining exposure of the image capturing element 150. The horizontal axis is the time axis, and the vertical axis shows, in order from top, readout rows from a first row to an nth row of the image capturing element 150. A time difference between adjacent rows in a rolling shutter method is denoted as Δt. A length of a long side of a rectangle corresponding to each readout row corresponds to exposure time.

In the image capturing element 150, a plurality of photoelectric conversion elements are arranged in a matrix. At timing at which exposure starts, exposure of pixels corresponding to the first pixel row of the image capturing element 150 is started. Then, after passage of Δt, exposure of pixels corresponding to the second pixel row is started. A time difference between the second row and the third row, and a time difference between the third row and the fourth row, are both Δt. For example, in a case in which the final readout row is the nth row, an exposure time difference (denoted as t) from the first row to the nth row is “t=n·Δt.” Rolling shutter distortion occurs due to the exposure time difference t, referred to as curtain speed. Although FIG. 5 exemplifies a configuration in which readout is performed in order from the first row to the nth row of the image capturing element 150, the image capturing element 150 may also have a configuration in which readout is performed in order from the nth row to the first row. It should be noted that what kind of rolling shutter distortion occurs is described below.

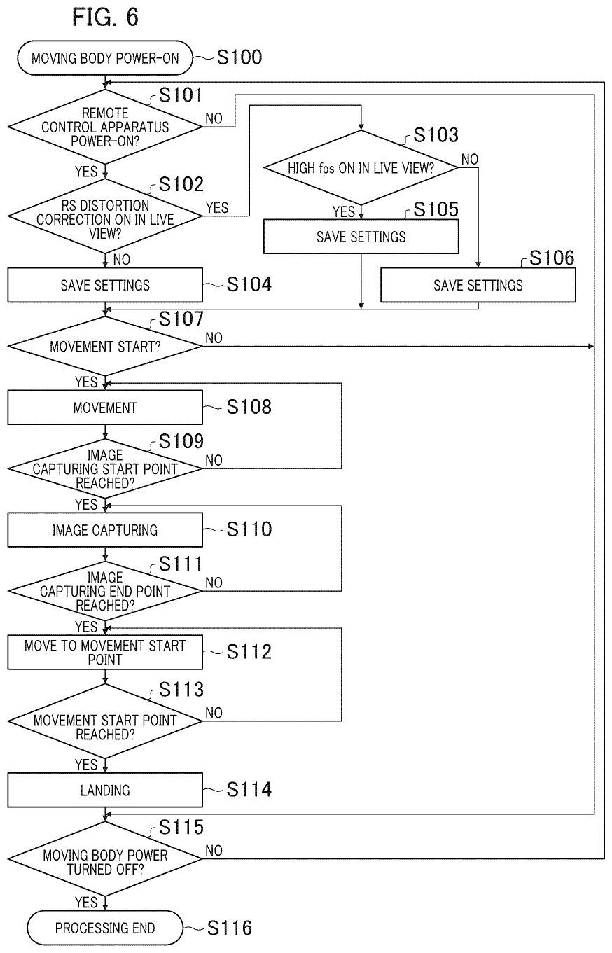

Referring to FIG. 6, processing in which the image capturing apparatus 100 performs image capturing of still images used for surveying while the moving body 10 moves is explained. FIG. 6 is a flowchart for explaining a flow of the processing. In step S100, the power switch of the moving body 10 is operated and electric power is turned on. The moving body control unit 21 executes startup processing of the moving body 10. Electric power is supplied to the image capturing apparatus 100 via the power supply output terminal 18 and the power supply input terminal 120, and the image capturing apparatus 100 starts up. Then, the processing proceeds to step S101.

In step S101, the control unit 605 of the remote control apparatus 600 determines whether or not the power switch of the remote control apparatus 600 has been operated. In a case in which the power switch of the remote control apparatus 600 has been operated and it is determined that power-on has been performed, the processing proceeds to step S102. In addition, in a case in which it is determined that power-on has not been performed, the processing proceeds to step S115.

In step S102, the control unit 605 of the remote control apparatus 600, based on operation instructions of the operation unit 603 by the operator, performs determination as to whether rolling shutter distortion correction relating to live view video is set to ON. Hereinafter, live view video is also denoted as “LV video,” and rolling shutter distortion correction is also denoted as “RS distortion correction.” In a case in which RS distortion correction is determined to be set to ON, the processing proceeds to step S103. In addition, in a case in which RS distortion correction is determined not to be set to ON, the processing proceeds to step S104.

In step S103, the control unit 605 of the remote control apparatus 600, based on operation instructions of the operation unit 603 by the operator, performs determination as to whether the high frame rate mode for LV video is set to ON. The unit of frame rate is “frames per second,” and is denoted as “fps.” The high frame rate mode is a mode in which a value of fps exceeds a predetermined threshold value. In a case in which the high frame rate mode is determined to be set to ON, the processing proceeds to step S105. In addition, in a case in which the high frame rate mode is determined not to be set to ON, the processing proceeds to step S106.

In step S105, the control unit 605 of the remote control apparatus 600 transmits, by the wireless communication unit 604, a first signal indicating that the setting of the high frame rate mode for LV video is ON. The wireless communication unit 15 of the moving body 10 notifies ON information of the setting to the moving body control unit 21 by receiving the first signal. The moving body control unit 21 stores ON information of the setting in the moving body memory unit 16. Next, the processing proceeds to step S107.

In step S106, the control unit 605 of the remote control apparatus 600 transmits, by the wireless communication unit 604, a second signal indicating that the setting of the high frame rate mode for LV video is OFF. The wireless communication unit 15 of the moving body 10 notifies OFF information of the setting to the moving body control unit 21 by receiving the second signal. The moving body control unit 21 stores OFF information of the setting in the moving body memory unit 16. Next, the processing proceeds to step S107.

In step S104, the control unit 605 of the remote control apparatus 600 transmits, by the wireless communication unit 604, a third signal indicating that the setting of RS distortion correction for LV video is OFF. The wireless communication unit 15 of the moving body 10 notifies OFF information of the setting to the moving body control unit 21 by receiving the third signal. The moving body control unit 21 stores OFF information of the setting in the moving body memory unit 16. Next, the processing proceeds to step S107.

In step S107, the control unit 605 of the remote control apparatus 600 performs determination of whether or not a movement start operation for the moving body 10 has been performed based on operation instructions of the operation unit 603 by the operator. In a case in which the movement start operation is determined to have been performed, the processing proceeds to step S108. In addition, in a case in which the movement start operation is determined not to have been performed, the processing proceeds to step S115. It should be noted that, in a case in which the moving body 10 moves based on a pre-programmed movement pattern and the like, determination of whether or not a movement start time has been reached may be performed in step S107.

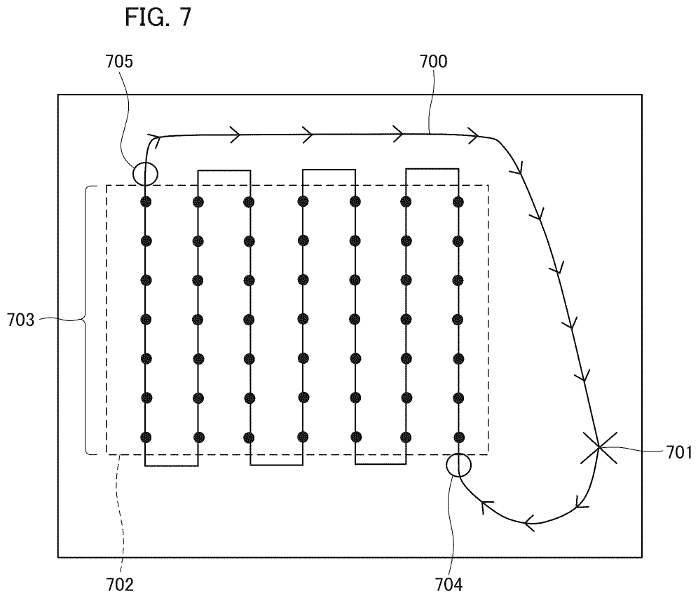

In step S108, movement start processing of the moving body 10 is executed. The control unit 605 of the remote control apparatus 600 transmits, by the wireless communication unit 604, a movement start signal. The wireless communication unit 15 of the moving body 10 notifies the moving body control unit 21 by receiving the movement start signal. The moving body control unit 21 starts movement of the moving body 10. Movement control of the moving body 10 is automatically performed based on information of a movement path recorded in advance in the moving body memory unit 16. The movement path of the moving body 10 is described below by using FIG. 7.

In step S109, after the processing of step S108, the moving body control unit 21 performs determination of whether or not the moving body 10 has reached an image capturing start point based on an output result of the position acquisition unit 14. In a case in which the moving body 10 is determined to have reached the image capturing start point, the processing proceeds to step S110. In addition, in a case in which the moving body 10 is determined not to have reached the image capturing start point, the processing continues by returning to step S108.

In step S110, still image capturing for performing surveying of a surveying range is started. The image capturing apparatus 100 comprehensively performs still image capturing in a predetermined surveying range. It should be noted that after all processing shown in FIG. 6 is completed, processing to merge a plurality of captured still images and generate one captured image for the surveying range is performed. The captured image is a surveying result acquired by drone mapping. After step S110, the processing proceeds to step S111.

In step S111, the moving body control unit 21 performs determination, based on an output result of the position acquisition unit 14, of whether or not the moving body 10 has reached an image capturing end point. In a case in which the moving body 10 is determined to have reached the image capturing end point, the processing proceeds to step S112. In addition, in a case in which the moving body 10 is determined not to have reached the image capturing end point, the processing continues by returning to step S110.

In step S112, the moving body control unit 21 executes processing to move the moving body 10 toward a movement start point, and next the processing proceeds to step S113. In step S113, the moving body control unit 21 performs determination, based on an output result of the position acquisition unit 14, of whether or not the moving body 10 has reached the movement start point. In a case in which the moving body 10 is determined to have reached the movement start point, the processing proceeds to step S114. In addition, in a case in which the moving body 10 is determined not to have reached the movement start point, the processing continues by returning to step S112.

In step S114, the moving body control unit 21 performs processing to land the moving body 10 and stop the drive unit 13. Next, in step S115, the moving body control unit 21 performs determination of whether or not the power of the moving body 10 has been turned off. In a case in which the power of the moving body 10 is determined to have been turned off, the processing proceeds to step S116 and the series of processing ends. In addition, in a case in which the power is determined to be turned on, the processing continues by returning to step S101.

Referring to FIG. 7, a movement path of the moving body 10 is explained. FIG. 7 is a schematic diagram showing an example of a movement path of the moving body 10. A movement path line 700 is a line indicating a movement path of the moving body 10. For convenience, although the movement path line 700 is illustrated as a plan view, actual movement of the flying moving body 10 is three-dimensional movement. A movement start point 701 indicated by an × mark is a point at which the moving body 10 starts movement. It should be noted that a user at the movement start point 701 monitors movement of the moving body 10 using the remote control apparatus 600.

A surveying range 702 indicated by a broken-line rectangular frame in FIG. 7 is a range in which still image capturing for surveying is performed. Image capturing point groups 703 in the surveying range 702 are each a set of image capturing points at which still image capturing is performed by the image capturing apparatus 100. Each image capturing point that configures the image capturing point groups 703 is indicated by a black dot. An image capturing start point 704 indicates a position immediately before the moving body 10 enters the surveying range 702. An image capturing end point 705 indicates a position immediately after the moving body 10 exits from the surveying range 702.

In FIG. 7, after the moving body 10 passes through the image capturing end point 705, the moving body 10 returns toward the movement start point 701. Information of a movement path includes information from when the moving body 10 takes off from the movement start point 701 to when the moving body 10 returns to the movement start point 701 again and lands. Processing of S108 (FIG. 6) corresponds to processing in which the moving body 10 takes off from the movement start point 701 and moves to the image capturing start point 704 while flying. In S110, the image capturing apparatus 100 comprehensively performs still image capturing at each image capturing point over the surveying range 702. In S111, based on an output result of the position acquisition unit 14, the moving body control unit 21 determines whether or not the moving body 10 has reached the image capturing end point 705. In a case in which the moving body 10 is determined to have reached the image capturing end point 705, in S112, the moving body control unit 21 performs processing to move the moving body 10 toward the movement start point 701. In S113, based on an output result of the position acquisition unit 14, in a case in which the moving body 10 is determined to have reached the movement start point 701, in S114, the moving body control unit 21 performs processing to land the moving body 10 and stop the drive unit 13.

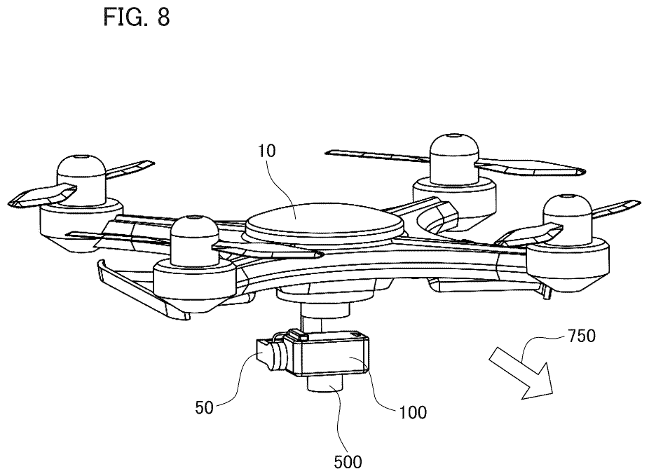

FIG. 8 is an external perspective view showing the moving body 10 that is performing still image capturing for surveying. The movement direction of the moving body 10 is conveniently indicated by an arrow 750. In a state in which the pitch movable unit 53 is rotated, the image capturing apparatus 100 performs image capturing by directing the interchangeable lens 500 downward. That is, the moving body 10 is in a state in which the moving body 10 can capture images of the ground.

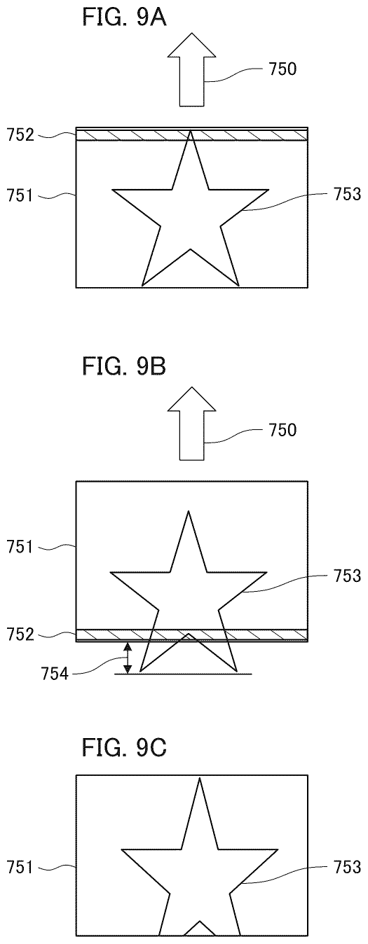

For efficiency of surveying, since image capturing by the image capturing apparatus 100 is performed while the moving body 10 moves in a movement direction indicated by the arrow 750, rolling shutter distortion may occur. The rolling shutter distortion is explained specifically using FIGS. 9A and 9C. FIGS. 9A and 9C are schematic diagrams for explaining occurrence of rolling shutter distortion. FIG. 9A is a diagram showing exposure start. FIG. 9B is a diagram showing exposure end. FIG. 9C is a diagram showing a still image acquired when exposure is performed from FIG. 9A to FIG. 9B.

In FIGS. 9A to 9C, an image capturing range 751 is a range in which image capturing on the image capturing element 150 is possible. Exposure positions 752 shown in FIGS. 9A and 9B are positions at which exposure on the image capturing element 150 is performed at a timing corresponding to each figure. For convenience, a subject is a star-shaped subject in the surveying range 702, and a subject region 753 is shown. A double-headed arrow 754 shown in FIG. 9B represents a rolling shutter distortion amount.

At a time point of exposure start shown in FIG. 9A, the subject region 753 fits within the image capturing range 751. However, as shown in FIG. 5, in a case in which an exposure time difference t occurs in the image capturing element 150, at a time point of exposure end shown in FIG. 9B, because the moving body 10 is moving in the movement direction (the direction of the arrow 750), the subject region 753 does not fit within the image capturing range 751. In FIG. 9B, the subject region 753 protrudes toward a lower side of the figure relative to the image capturing range 751. The protrusion amount corresponds to the rolling shutter distortion amount (double-headed arrow 754).

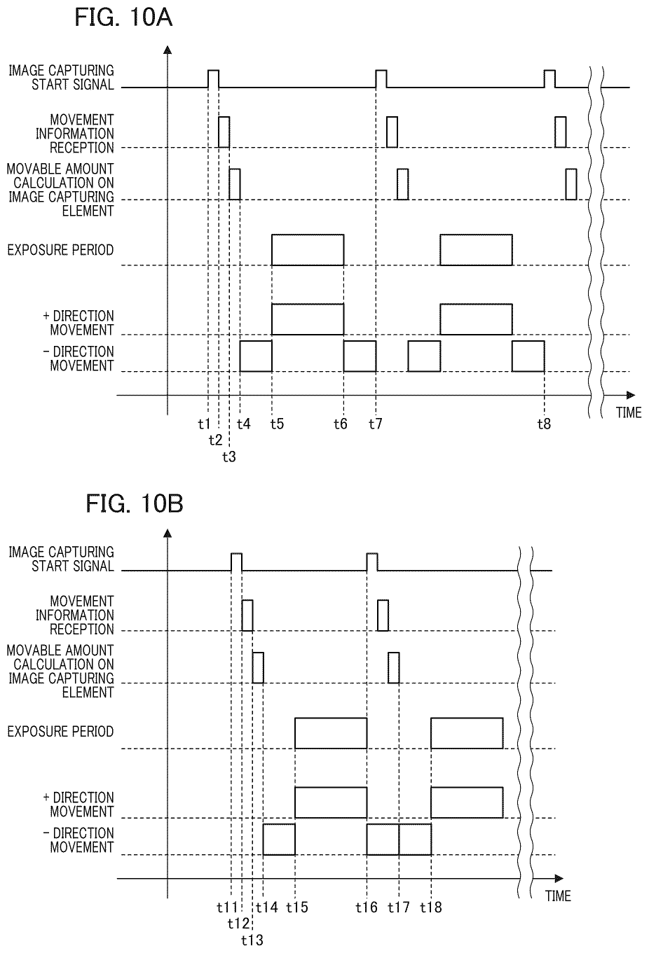

In a still image that is output, as shown in FIG. 9C, a part of the subject region 753 is missing. The subject region 753 protrudes on the lower side in the image capturing range 751, and a range that is captured decreases by an amount corresponding to the rolling shutter distortion amount shown in FIG. 9B. This means that image capturing points included in the image capturing point groups 703 shown in FIG. 7 must be increased. In addition, as shown in FIG. 9C, an image of the subject region 753 is stretched in a vertical direction in the figure, and an aspect ratio changes (distortion of aspect ratio). The aspect-ratio change is a significant disadvantage in image capturing for surveying in which acquisition of accurate still images is necessary. In the present embodiment, RS distortion correction processing is performed with respect to disadvantages (decrease of the image capturing range, collapse of aspect ratio) caused by rolling shutter distortion. The RS distortion correction processing is explained by referring to FIGS. 10A and 10B.

FIGS. 10A and 10B are timing charts for explaining RS distortion correction processing in the present embodiment. FIG. 10A shows the processing when the high frame rate mode for LV video is set to OFF in step S103 (FIG. 6), or during still image capturing at the image capturing points of the image capturing point groups 703. FIG. 10B shows the processing when the high frame rate mode for LV video is set to ON in step S103. The execution subject of the processing shown in FIGS. 10A and 10B is the control unit 180 of the image capturing apparatus 100.

The vertical axes of FIGS. 10A and 10B show the following timings:
The image capturing start timing of the image capturing apparatus 100
The reception timing of movement information from the moving body 10
The calculation timing of a movable amount on the image capturing element
The timing related to an exposure period of the image capturing element 150
The timing related to a movement period of the image capturing element 150 in predetermined directions (+direction, −direction)

The horizontal axes of FIGS. 10A and 10B are time axes. In FIG. 10A, times t1 to t8 are shown on the time axis, and in FIG. 10B, times t11 to t18 are shown on the time axis. In each figure, the larger the number appended to the symbol “t,” the later the time.

Each period in FIG. 10A is as follows:
First period (t1 to t2): indicates a period in which the moving body control unit 21 sends an image capturing start signal from the moving body 10 to the image capturing apparatus 100 via the image capturing signal output terminal 19. The image capturing start signal occurs before the exposure period (t5 to t6).

Second period (t2 to t3): indicates a period in which movement information is sent from the moving body 10 to the image capturing apparatus 100 via the movement information input/output terminal 20. The movement information includes a movement direction of the moving body 10, a movement speed of the moving body 10, and altitude information of the moving body 10. For example, during the second period, the control unit 180 transmits to the moving body 10 a request signal that requests transmission of the movement information. Upon receiving the request signal, the moving body control unit 21 performs processing to transmit a signal of the movement information to the image capturing apparatus 100.

Third period (t3 to t4): indicates a period during which the control unit 180 calculates a movable amount on the image capturing element. The movable amount on the image capturing element is a movable amount that the image capturing element drive apparatus 220 causes the image capturing element 150 to move in order to perform RS distortion correction. In addition to the movement information, the control unit 180 calculates the movable amount on the image capturing element based on a focal length of an image capturing optical system in the interchangeable lens 500 that is stored in the memory unit 190. Specifically, the movable amount on the image capturing element is denoted as d (mm). The focal length relating to the interchangeable lens 500 is denoted as f (mm). A movement speed of the moving body 10 is denoted as v (m/s). An exposure time is denoted as T(s). An altitude of the moving body 10 is denoted as h (m). The movable amount on the image capturing element d (mm) can be expressed by the following equation:

$$d = ( f \cdot v \cdot T ) / h \qquad ( 1 )$$

Fourth period (t4 to t5): indicates a period during which the image capturing element 150 is moved by the image capturing element drive apparatus 220. The control unit 180 obtains one half of the movable amount on the image capturing element d that is calculated by Equation (1) and calculates a target drive amount and a drive direction (movement direction) of the image capturing element 150 corresponding to the amount (d/2). A first drive direction corresponding to the movement direction of the moving body 10 is defined as the—direction (minus direction), and a second drive direction corresponding to the opposite direction is defined as the +direction (plus direction). The fourth period indicates a period during which, relative to the movement direction of the moving body 10, the image capturing element drive apparatus 220 moves the image capturing element 150 in the—direction.

Fifth period (t5 to t6): indicates an exposure period of the image capturing element 150. Although the length of the exposure period (exposure time) is the time obtained by adding the exposure time difference t and a time corresponding to the shutter speed, for convenience the explanation is performed on the assumption that the shutter speed is sufficiently fast with respect to a speed corresponding to the exposure time difference t.

In the present embodiment, during the fifth period, drive control is performed to move the image capturing element 150 by the image capturing element drive apparatus 220 in a direction opposite to a movement direction of the moving body 10 by an amount equal to the movable amount on the image capturing element. Specifically, relative to the movement direction of the moving body 10, the image capturing element drive apparatus 220 moves the image capturing element 150 in the +direction. Processing to move the image capturing element 150 in the +direction is processing to move the image capturing element 150 toward a lower side of the figure by an amount corresponding to the rolling shutter distortion amount (double-headed arrow 754) shown in FIGS. 9A and 9C. By the processing, the rolling shutter distortion amount can be reduced.

During the fifth period, based on vibration detected by the shake detection unit 170, the control unit 180 outputs a control command to the image capturing element drive apparatus 220 by further superimposing a movable amount for blur correction on the target drive amount. By performing drive (movement) of the image capturing element 150 in accordance with the control command, the image capturing element drive apparatus 220 can also correct image blur due to vibration.

Sixth period (t6 to t7): Indicates a period in which the image capturing element drive apparatus 220 moves the image capturing element 150 in the—direction to return the image capturing element 150 to the center position of the movable range. The control unit 180 acquires a position detection signal from the image capturing element position detection unit 230. Based on a position detection value, the control unit 180 detects the extent to which the image capturing element 150 is displaced relative to the center position of the movable range, and performs control of the image capturing element drive apparatus 220 to return the image capturing element 150 to the center position.

Seventh period (t7 to t8): Indicates a period in which the next image capturing is performed. Processing similar to the processing during the period from time t1 to time t7 is performed.

Processing during still image capturing at the respective image capturing points that configure the image capturing point groups 703 is completed in the period from time t1 to time t7. For example, although a transition to still image capturing at an (N+1)th image capturing point is assumed when still image capturing at an Nth image capturing point is completed, movement from the Nth image capturing point to the (N+1)th image capturing point takes approximately 1 second. In this case, a transition to still image capturing at the (N+1)th image capturing point cannot be performed immediately, and image capturing for LV video is performed during a transient period of movement. In a case in which a high frame rate mode for LV video is set to OFF, processing indicated in the period from time t1 to time t7 is repeatedly performed for capturing of LV video.

Time obtained by adding a length of the fourth period (t4 to t5) and a length of the sixth period (t6 to t7) is approximately the same as a length of the fifth period (t5 to t6). That is, because a frame rate of LV video becomes slower by a time corresponding to time obtained by adding a length of the fourth period and a length of the sixth period, there is a possibility that smooth video required for LV video cannot be provided. Therefore, by referring to FIG. 10B, a case in which a high frame rate mode for LV video is set to ON in step S103 shown in FIG. 6 is explained. By processing that is executed in the setting, smooth LV video can be provided.

In FIG. 10B, times t11 to t14 respectively correspond to times t1 to t4 shown in FIG. 10A. Because periods of t11 to t14 are equivalent to periods of t1 to t4 shown in FIG. 10A, the explanation thereof is omitted.

A period of t14 to t15 is a period in which, relative to the movement direction of the moving body 10, the image capturing element 150 is moved in the—direction. The ratio with respect to the movable amount on the image capturing element differs from that in the fourth period (t4 to t5) shown in FIG. 10A. During the period from t14 to t15, the control unit 180 obtains one fourth of the movable amount d on the image capturing element calculated by Equation (1) and calculates a target drive amount of the image capturing element 150 corresponding to the amount d/4.

A period of t15 to t16 is an exposure period of the image capturing element 150. A ratio with respect to a movable amount on the image capturing element is different from a ratio with respect to a movable amount on the image capturing element of the fifth period (t5 to t6) shown in FIG. 10A. Although an exposure time in the period of t15 to t16 is equivalent to an exposure time of the fifth period and a drive direction is the +direction, the control unit 180 obtains an amount of one half of the movable amount d on the image capturing element that is calculated by Equation (1), and calculates a target drive amount of the image capturing element 150 that corresponds to the amount (d/2). That is, in the period of t15 to t16, a reduction amount of rolling shutter distortion becomes approximately one half compared with the fifth period.

A period of t16 to t17 is a period in which the image capturing element 150 is moved in the—direction by the image capturing element drive apparatus 220 to return the image capturing element 150 to a center position of the movable range. The control unit 180, based on a detection value of the image capturing element position detection unit 230, detects to what extent the image capturing element 150 is displaced relative to a center position of the movable range, and performs processing to return the image capturing element 150 to the center position of the movable range by the image capturing element drive apparatus 220. In the period of t15 to t16, a movable amount on the image capturing element is an amount of one-half of the movable amount on the image capturing element d, and in the period of t14 to t15, a movable amount on the image capturing element is an amount of one-fourth of the movable amount on the image capturing element d. Therefore, in the period of t16 to t17, a movable amount on the image capturing element becomes an amount of one-fourth of the movable amount on the image capturing element d.

A period of t17 to t18 is a period in which the image capturing element 150 is moved in the—direction relative to a movement direction of the moving body 10. The control unit 180 obtains an amount of one-fourth of the movable amount on the image capturing element d calculated by Equation (1), and calculates a target drive amount of the image capturing element 150 corresponding to the amount (d/4).

In the present embodiment, processing equivalent to the processing in the period of t11 to t14 is performed within the period of t16 to t17. Accordingly, the overall processing time can be shortened. In order to continue image capturing to acquire LV video, processing similar to processing in the period of t14 to t17 is continuously executed.

Although the image capturing element 150 moves by an amount corresponding to the movable amount on the image capturing element in the fifth period (t5 to t6) shown in FIG. 10A, in the period of t15 to t16 shown in FIG. 10B the image capturing element 150 moves by an amount corresponding to one half of the movable amount on the image capturing element d. Accordingly, an amount by which the image capturing element 150 moves during a period obtained by adding a period of t14 to t15 and a period of t16 to t17 becomes one half of an amount by which the image capturing element 150 moves during a period obtained by adding the fourth period (t4 to t5) and the sixth period (t6 to t7) shown in FIG. 10A. That is, a time obtained by adding a length of the period of t14 to t15 and a length of the period of t16 to t17 can be suppressed to one half of a time obtained by adding a length of the fourth period (t4 to t5) and a length of the sixth period (t6 to t7). Therefore, by shortening the period of t14 to t17, the frame rate of LV video can be increased.

Although a reduction amount of rolling shutter distortion in the processing shown in FIG. 10B is approximately one half of a reduction amount of rolling shutter distortion in the processing shown in FIG. 10A, smooth video necessary for LV video can be provided. For example, the exposure time (a length of the period of t15 to t16) is approximately equal to the exposure time difference t, and tis 22 ms. A time obtained by adding a length of the period of t14 to t15 and a length of the period of t16 to t17 is 11 ms. In this case, image capturing for LV video can be performed at a frame rate of 30 fps.

### Modification Embodiment

Next, a modified embodiment of the present embodiment is explained. It should be noted that the explanation of the modified embodiment is likewise applicable to embodiments described below within a range that does not cause contradictions in control.

Although, in the period of t15 to t16 shown in FIG. 10B, the movable amount on the image capturing element was set to one half of the movable amount d on the image capturing element in the fifth period (t5 to t6) shown in FIG. 10A, the movable amount on the image capturing element is not limited to this example. In the modified embodiment, an arbitrary ratio is set such that the movable amount on the image capturing element in the period of t15 to t16 becomes smaller than the movable amount on the image capturing element in the fifth period. In a case in which the movable amount on the image capturing element is small because the movement speed of the moving body 10 is slow, processing in the period of t14 to t17 shown in FIG. 10B can also be performed within a period corresponding to the set frame rate. In that case, in the period of t15 to t16, the control unit 180 performs processing to move the image capturing element 150 by the image capturing element drive apparatus 220 by calculating a target drive amount corresponding to the movable amount d on the image capturing element.

In addition, in a case in which a decrease in frame rate occurs because a processing load of the control unit 180 is large, the control unit 180 of the modified embodiment performs processing described below. With respect to calculation of the movable amount on the image capturing element that is performed during a period of t16 to t17 for each image capturing in the embodiment, the control unit 180 performs calculation of the movable amount on the image capturing element only in a case in which predetermined conditions are satisfied. The predetermined conditions are that, from a time point at which the control unit 180 previously performed calculation of the movable amount on the image capturing element, a change amount of a movement speed of the moving body 10 or a change amount of an altitude becomes equal to or greater than a threshold value. By executing calculation processing of the movable amount on the image capturing element only in a case in which the control unit 180 determines that the predetermined conditions are satisfied, a frequency of calculation can be reduced. As a result, a processing load of the control unit 180 can be made smaller, and a decrease in frame rate can be suppressed.

In addition, the embodiment is not limited to a case in which movement speed information, movement direction information, and altitude information of the moving body 10 are acquired by the moving body 10. In the modified embodiment, by installing a position acquisition unit configured by GNSS in the image capturing apparatus 100, movement speed information, movement direction information, and altitude information can be acquired inside the image capturing apparatus 100. Although calculation processing of the movable amount on the image capturing element is performed based on altitude information of the moving body 10 as a value of subject distance information in the above-described embodiment, the processing is not limited to the example. The image capturing system of the modified embodiment is provided with a distance measuring apparatus capable of directly measuring a subject distance (a distance between an image capturing unit and the subject), and the control unit 180 can calculate the movable amount on the image capturing element by using the measured subject distance in place of the altitude information of the moving body 10.

Although, for convenience, RS distortion correction in a vertical direction in the figures shown in FIGS. 9A and 9C was explained in the embodiment, the RS distortion correction is not limited to this example. The control unit 180 of the modified embodiment can perform RS distortion correction in arbitrary directions parallel to an image capturing plane of the image capturing element 150.

Although in the embodiment a configuration example was shown in which RS distortion correction moves the image capturing element 150 by the image capturing element drive apparatus 220, as a modified embodiment there is a control form in which the control unit 180 moves a lens for image blur correction (a shift lens and the like) that configures the image capturing optical system by a drive unit. In addition, there is a control form that uses both movement of the image blur correction lens and movement of the image capturing element. The image capturing optical system is an optical system that is configured by a plurality of optical members (a lens, an aperture, and the like) in an interchangeable lens, or is an optical system that is configured by a plurality of optical members in a lens unit provided in the image capturing apparatus.

In addition, the embodiment is not limited to a case in which the control unit 180 and the moving body control unit 21 are each provided with a processor. For example, there is a modified embodiment in which the moving body control unit 21 is eliminated and functions of the moving body control unit 21 are integrated into the control unit 180. Alternatively, there is a modified embodiment in which the control unit 180 is eliminated and functions of the control unit 180 are integrated into the moving body control unit 21.

In the above-described embodiments, control is performed to move the image capturing element or the image blur correction lens in accordance with a first drive amount calculated by the control unit 180 during image capturing for acquiring still images. In addition, control is performed to move the image capturing element or the image blur correction lens in accordance with a second drive amount calculated by the control unit 180 during image capturing for acquiring display video (LV video). Alternatively, control is performed to move the image capturing element or the image blur correction lens in accordance with a first drive amount calculated by the control unit 180 during first image capturing for acquiring display video at a first frame rate. In addition, control is performed to move the image capturing element or the image blur correction lens in accordance with a second drive amount calculated by the control unit 180 during second image capturing for acquiring display video at a second frame rate higher than the first frame rate. By changing from the first drive amount to the second drive amount, an image capturing apparatus capable of acquiring smooth video data required for LV video while suppressing occurrence of rolling shutter distortion during image capturing relating to LV video can be provided.

### Second Embodiment

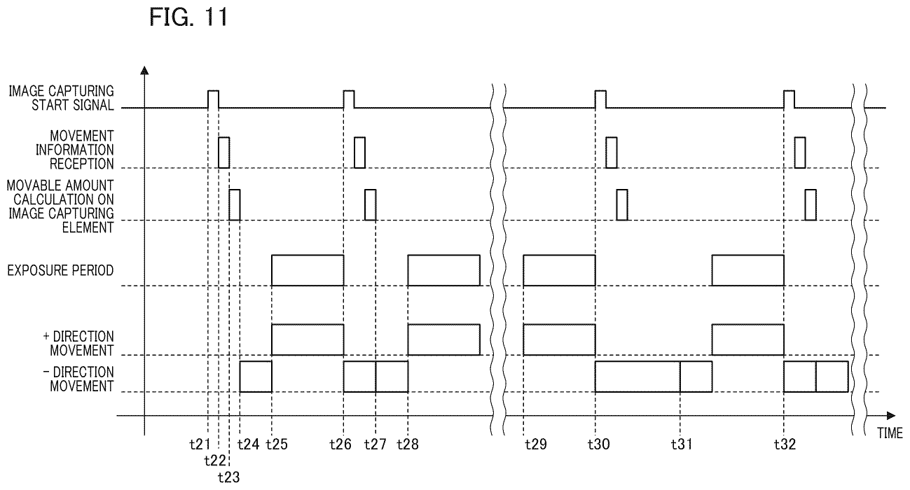

Referring to FIG. 11, a Second embodiment is explained. In the present embodiment, explanation is omitted for matters similar to the embodiment, and differences are mainly explained. Such a method of omission of explanation is the same in embodiments described below.

In the present embodiment, processing with respect to a case in which it is desired to further increase a frame rate during image capturing for LV video is explained in detail by using FIG. 11. FIG. 11 is a timing chart for explaining RS distortion correction processing in the present embodiment. Times t21 to t32 are each indicated on a time axis. Because periods of t21 to t26 are equivalent to periods of t11 to t16 shown in FIG. 10B, an explanation thereof is omitted.

A period of t26 to t27 corresponds to the period of t16 to t17 shown in FIG. 10B. In the period of t26 to t27, processing to move the image capturing element 150 in the—direction corresponding to a movement direction of the moving body 10 is performed. At that time, a difference from the period of t16 to t17 is that the image capturing element 150 is not moved to the center position of the movable range.

A period of t27 to t28 corresponds to a period of t17 to t18 shown in FIG. 10B. The control unit 180 calculates a target drive amount corresponding to an amount smaller than one-fourth of the movable amount on the image capturing element d and performs drive control of the image capturing element 150.

The movable amount on the image capturing element in a period of t26 to t28 shown in FIG. 11 is smaller than an amount obtained by adding the movable amount on the image capturing element in a period of t14 to t15 and the movable amount on the image capturing element in a period of t16 to t17 shown in FIG. 10B. A length of the period of t26 to t28 is shorter than time obtained by adding a length of the period of t14 to t15 and a length of the period of t16 to t17. Therefore, the frame rate can be made even higher by processing shown in FIG. 11.

During image capturing for acquiring LV video, processing of t25 to t28 is repeatedly executed. The movable amount on the image capturing element in a period of t26 to t28 is smaller than the movable amount on the image capturing element in a period of t25 to t26. That is, in a case in which processing of t25 to t28 is repeatedly executed, the image capturing element 150 approaches an end of the movable range in the +direction corresponding to a direction opposite to a movement direction of the moving body 10. The end of the movable range corresponds to a limit position of the image capturing element 150 moved by the image capturing element drive apparatus 220.

Therefore, at the timing at which the exposure period t29 to t30 shown in FIG. 11 has elapsed, the control unit 180 executes processing to move the image capturing element 150 toward the center position of the movable range. During the period t30 to t31, similar to the period t26 to t27, the image capturing element 150 moves in a direction that approaches the center position of the movable range. However, based on an output result of the image capturing element position detection unit 230, the control unit 180 determines whether or not the detected position of the image capturing element 150 has become equal to or less than a predetermined distance (threshold value) with respect to an end of the movable range. In a case in which this determination condition is satisfied, the control unit 180 simultaneously performs processing to return the image capturing element 150 to the center position of the movable range. In the period t30 to t31 shown in FIG. 11, it is determined that this determination condition is satisfied, and processing to return the image capturing element 150 to the center position of the movable range is performed. Therefore, because the period t30 to t31 is longer than the period t26 to t27, an image capturing period that includes the period t30 to t31 becomes longer. However, because periods other than the period t30 to t31 are short, a merit that the frame rate can be increased as a whole can be obtained. In image capturing periods relating to subsequent LV video, processing similar to the period t25 to t28 is repeatedly executed.

According to the present embodiment, it is possible to provide LV video at a higher frame rate as compared with the first embodiment.

### Third Embodiment

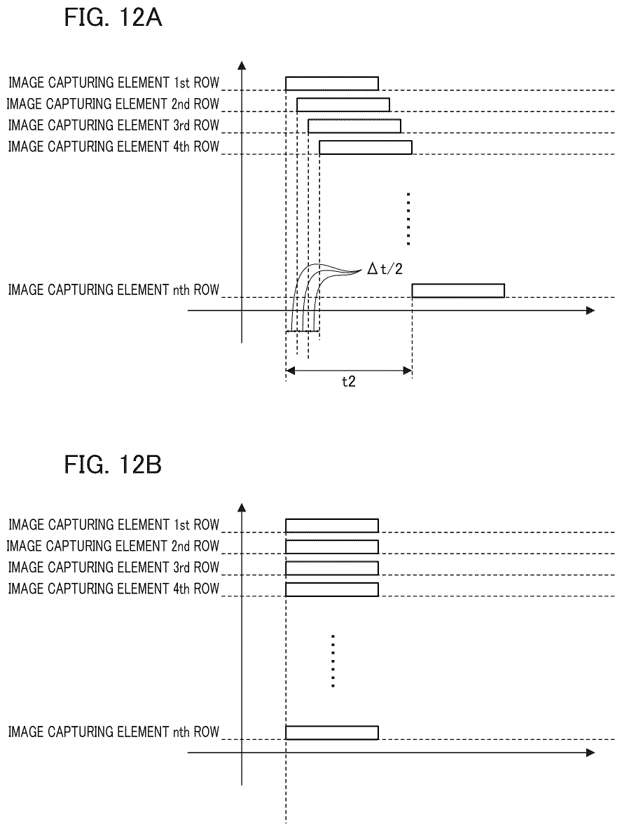

Referring to FIGS. 12A and 12B, a third embodiment is explained. In the first embodiment, explanation is performed by setting an exposure time difference t (FIG. 5) as constant. In the present embodiment, processing with respect to an image capturing element in which the exposure time difference t is changeable, or an image capturing element in which the exposure time difference can be changed to t=0, is explained.

FIGS. 12A and 12B are timing charts for explaining exposure of the image capturing element 150 according to the present embodiment. Referring to FIG. 12A, exposure in a case in which the exposure time difference tis shortened is explained. In addition, referring to FIG. 12B, exposure in a case in which no curtain-speed time is required is explained.

FIG. 12A differs from FIG. 5 in that the exposure time difference is one-half. At timing of exposure start, exposure of pixels corresponding to a first pixel row of the image capturing element 150 is started. Then, after passage of time Δt/2, exposure of pixels corresponding to a second pixel row is started. In a case in which pixel rows extend to an nth row, an exposure time difference across pixel rows from the first row to the nth row is denoted as t2. Time of “exposure time difference t2=n·Δt/2” elapses from the first row to the nth row, although the time is one-half with respect to “exposure time difference t=n·Δt” shown in FIG. 5. That is, rolling shutter distortion can be reduced to one-half. Hereinafter, a mode using the exposure method is referred to as a high-speed curtain speed mode. It should be noted that disadvantages of the high-speed curtain speed mode include that dynamic range generally decreases and noise in dark locations increases, and the like.

An exposure time difference in FIG. 12B is zero or within an allowable range (the exposure time difference is equal to or less than a threshold time). The exposure time difference t of FIG. 5 and the exposure time difference t2 of FIG. 12A are not generated. Hereinafter, a mode using an exposure method called a global shutter method is referred to as a global shutter mode. It should be noted that disadvantages of the global shutter mode include that dynamic range generally decreases further than in the high-speed curtain speed mode and noise in dark locations increases, and the like.

Furthermore, a mode using the exposure method explained in FIG. 5 is explained below as a normal curtain speed mode. In a period of t3 to t4 shown in FIG. 10A and in a period of t13 to t14 shown in FIG. 10B, the control unit 180 calculates the movable amount on the image capturing element and performs drive control of the image capturing element 150 using a target drive amount corresponding to the calculated movable amount on the image capturing element. At that time, in a case in which the control unit 180 determines that the position of the image capturing element 150 will exceed a limit of the movable range, the control unit 180 performs processing to change the exposure method of the image capturing element 150 from the normal curtain speed mode to the high-speed curtain speed mode. By the mode change, the exposure time difference changes from t to t2 and becomes one-half. Accordingly, the movable amount on the image capturing element can be made one-half.

Furthermore, in a case in which the control unit 180 determines that a position of the image capturing element 150 will exceed a limit of the movable range even when changing from the normal curtain speed mode to the high-speed curtain speed mode, the control unit 180 performs processing to change from the high-speed curtain speed mode to the global shutter mode. As shown in FIG. 12B, because an exposure time difference is not required in the global shutter mode, rolling shutter distortion does not occur. Accordingly, processing to move the image capturing element 150 by the image capturing element drive apparatus 220 in a period of t4 to t7 shown in FIG. 10A and a period of t14 to t17 shown in FIG. 10B need not be performed.

Because an amount of noise generation in dark locations is smaller in the normal curtain speed mode and the high-speed curtain speed mode compared to the global shutter mode, exposure of the image capturing element can be performed at a sufficiently high shutter speed.

In contrast, because an amount of noise generation in dark locations is large in the global shutter mode, shutter speed must be slowed. In this case, image blur corresponding to a decrease in shutter speed may occur. In order to correct the image blur, the control unit 180 can perform processing to move the image capturing element 150 by the image capturing element drive apparatus 220 in a period of t4 to t7 shown in FIG. 10A and a period of t14 to t17 shown in FIG. 10B.

In the present embodiment, it is possible to provide higher-quality LV video by changing from the normal curtain speed mode to the high-speed curtain speed mode, and by changing from the high-speed curtain speed mode to the global shutter mode. It should be noted that switching between rolling shutter and global shutter in accordance with user operation may be made possible.

### Other Embodiments

Although embodiments and modified embodiments of the present disclosure have been explained above, the present disclosure is not limited to the embodiments, and various modifications and changes are possible within a range of the gist thereof.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, an image capturing apparatus capable of acquiring smoother display video in which image distortion is suppressed can be provided.

This application claims the benefit of Japanese Patent Application No. 2024-218092, filed Dec. 12, 2024, which is herein in its entirety.

What is claimed is:

1. An image capturing apparatus comprising:
at least one memory storing instructions; and
at least one processor executing the stored instructions causing the image capturing apparatus to:
acquire movement information with respect to movement of the image capturing apparatus;
move an image capturing element or a lens that performs image blur correction in a direction parallel to an image capturing plane; and
perform control to move the image capturing element or the lens in accordance with the movement information during first image capturing for acquiring a still image and during second image capturing for acquiring display video,
wherein, in a case in which the image capturing apparatus performs image capturing while moving, during the first image capturing, executing the stored instructions by the processor further causes the image capturing apparatus to perform control to calculate a first drive amount and move the image capturing element or the lens, and during the second image capturing, executing the stored instructions by the processor further causes the image capturing apparatus to perform control to calculate a second drive amount and move the image capturing element or the lens.

2. An image capturing apparatus comprising:
at least one memory storing instructions; and
at least one processor executing the stored instructions causing the image capturing apparatus to:
acquire movement information with respect to movement of the image capturing apparatus;
move an image capturing element or a lens that performs image blur correction in a direction parallel to an image capturing plane; and
perform control to move the image capturing element or the lens in accordance with the movement information during first image capturing for acquiring display video at a first frame rate and during second image capturing for acquiring display video at a second frame rate higher than the first frame rate,
wherein, in a case in which the image capturing apparatus performs image capturing while moving, during the first image capturing, executing the stored instructions by the processor further causes the image capturing apparatus to perform control to calculate a first drive amount and move the image capturing element or the lens, and during the second image capturing, executing the stored instructions by the processor further causes the image capturing apparatus to perform control to calculate a second drive amount and move the image capturing element or the lens.

3. The image capturing apparatus according to claim 1,
wherein the second drive amount for moving the image capturing element or the lens during an exposure period of the image capturing element during the second image capturing is smaller than the first drive amount for moving the image capturing element or the lens during the exposure period of the image capturing element during the first image capturing.

4. The image capturing apparatus according to claim 2,
wherein the second drive amount for moving the image capturing element or the lens during an exposure period of the image capturing element during the second image capturing is smaller than the first drive amount for moving the image capturing element or the lens during the exposure period of the image capturing element during the first image capturing.

5. The image capturing apparatus according to claim 1,
wherein executing the stored instructions by the processor further causes the image capturing apparatus to perform control to move the image capturing element or the lens in a first direction parallel to the image capturing plane before exposure of the image capturing element is performed and to move the image capturing element or the lens in a second direction opposite to the first direction during an exposure period of the image capturing element.

6. The image capturing apparatus according to claim 2,
wherein executing the stored instructions by the processor further causes the image capturing apparatus to perform control to move the image capturing element or the lens in a first direction parallel to the image capturing plane before exposure of the image capturing element is performed and to move the image capturing element or the lens in a second direction opposite to the first direction during an exposure period of the image capturing element.

7. The image capturing apparatus according to claim 5,
wherein after the exposure period of the image capturing element has elapsed, executing the stored instructions by the processor further causes the image capturing apparatus to perform control to move the image capturing element or the lens in the first direction.

8. The image capturing apparatus according to claim 7,
wherein a drive amount for moving the image capturing element or the lens before the exposure of the image capturing element is performed and after the exposure period of the image capturing element has elapsed is smaller than a drive amount for moving the image capturing element or the lens during the exposure period of the image capturing element.

9. The image capturing apparatus according to claim 1 further comprising:
the image capturing element of a rolling shutter type in which a time difference of exposure occurs for each pixel row,
wherein executing the stored instructions by the processor further causes the image capturing apparatus to detect a position of the image capturing element or the lens,
wherein, in a case in which the position of the image capturing element or the lens is determined to exceed a limit of a movable range, executing the stored instructions by the processor further causes the image capturing apparatus to perform a change from a first mode in which the time difference of exposure is a first time difference to a second mode in which the time difference of exposure is smaller than the first time difference.

10. The image capturing apparatus according to claim 1,
wherein executing the stored instructions by the processor further causes the image capturing apparatus to detect a position of the image capturing element or the lens,
wherein, in a case in which the position of the image capturing element or the lens is determined to exceed a limit of a movable range, executing the stored instructions by the processor further causes the image capturing apparatus to perform a change from a first mode in which a time difference of exposure occurs for each pixel row in the image capturing element to a second mode in which the time difference of exposure for each pixel row in the image capturing element does not occur or the time difference is less than or equal to a threshold time.

11. The image capturing apparatus according to claim 1,
wherein executing the stored instructions by the processor further causes the image capturing apparatus to detect a position of the image capturing element or the lens,
wherein after an exposure period has elapsed, executing the stored instructions by the processor further causes the image capturing apparatus to perform control to move the image capturing element or the lens in a direction approaching a center position of a movable range based on the detected position of the image capturing element or the lens.

12. The image capturing apparatus according to claim 1,
wherein the image capturing apparatus is capable of being mounted on a moving body, executing the stored instructions by the processor further causes the image capturing apparatus to acquire the movement information from the moving body, and during the first image capturing and during the second image capturing, executing the stored instructions by the processor further causes the image capturing apparatus to perform control to move the image capturing element or the lens during an exposure period using a drive amount corresponding to a movable amount of the image capturing element or the lens that is calculated from the movement information and a focal length of an image capturing optical system configured to perform image formation on the image capturing element.

13. The image capturing apparatus according to claim 12,
wherein in a case in which image capturing related to the display video is performed, executing the stored instructions by the processor further causes the image capturing apparatus to perform calculation of a movable amount of the image capturing element or the lens in a case in which a change amount of a movement speed of the moving body from a time point when calculation of the movable amount of the image capturing element or the lens was previously performed is determined to be equal to or greater than a threshold value.

14. The image capturing apparatus according to claim 1,
wherein the image capturing apparatus is capable of being mounted on a moving body, and executing the stored instructions by the processor further causes the image capturing apparatus to perform calculation of a movable amount of the image capturing element or the lens based on a focal length, a movement speed of the moving body, an exposure time, and an altitude of the moving body.

15. The image capturing apparatus according to claim 2,
wherein the image capturing apparatus is capable of being mounted on a moving body, and executing the stored instructions by the processor further causes the image capturing apparatus to perform calculation of a movable amount of the image capturing element or the lens based on a focal length, a movement speed of the moving body, an exposure time, and an altitude of the moving body.

16. An image capturing system comprising:
the image capturing apparatus according to claim 1;
a moving body;
a connection apparatus configured to connect the image capturing apparatus and the moving body; and
a remote control apparatus configured to perform remote control of the moving body.

17. A control method for controlling an image capturing apparatus to move an image capturing element or a lens that performs image blur correction in a direction parallel to an image capturing plane, the method comprising:
acquiring movement information with respect to movement of the image capturing apparatus;
during first image capturing for acquiring a still image and during second image capturing for acquiring display video, performing control to move the image capturing element or the lens in accordance with the movement information; and
in a case in which the image capturing apparatus performs image capturing while moving, performing control to calculate a first drive amount during the first image capturing and move the image capturing element or the lens, and performing control to calculate a second drive amount during the second image capturing and move the image capturing element or the lens.

18. A control method for controlling an image capturing apparatus to move an image capturing element or a lens that performs image blur correction in a direction parallel to an image capturing plane, the method comprising:
acquiring movement information with respect to movement of the image capturing apparatus;
during first image capturing for acquiring display video at a first frame rate and during second image capturing for acquiring display video at a second frame rate higher than the first frame rate, performing control to move the image capturing element or the lens in accordance with the movement information; and
in a case in which the image capturing apparatus performs image capturing while moving, performing control to calculate a first drive amount during the first image capturing and move the image capturing element or the lens and performing control to calculate a second drive amount during the second image capturing and move the image capturing element or the lens.
